(19) United States
(12) Patent Application Publication
(10) Pub. No.: US 2023/0316122 A1
(43) Pub. Date: Oct. 5, 2023

(54) REINFORCEMENT LEARNING STABILITY OPTIMIZATION

(71) Applicant: International Business Machines Corporation, Armonk, NY (US)

(72) Inventors: Sathya Santhar, Ramapuram (IN); Sridevi Kannan, Katupakkam (IN); Sarbajit K. Rakshit, Kolkata (IN); Samuel Mathew Jawaharlal, Chennai (IN)

(21) Appl. No.: 17/706,686

(22) Filed: Mar. 29, 2022

(51) Int. Cl. G06N 20/00; G06K 9/62

(52) U.S. Cl. CPC G06N 20/00; G06K 9/6232; G06K 9/6256; G06K 9/6262

(57) ABSTRACT

A computer-implemented method for optimizing reinforcement learning based on a stability of a reinforcement learning state is disclosed. The computer-implemented method includes determining whether a stability of a next reinforcement learning state of a reinforcement learning problem is above a predetermined threshold. The computer-implemented method further includes responsive to determining that the stability of the next reinforcement state is below the predetermined threshold, determining a stability of an alternate next reinforcement learning state of the reinforcement learning problem. The computer-implemented method further includes responsive to determining that the stability of the next reinforcement state is above the predetermined threshold, transitioning from a current reinforcement learning state to the next reinforcement learning state based, at least in part, on determining that the stability of the next reinforcement learning state is above the predetermined threshold.

### BACKGROUND

The present invention relates generally to the field of reinforcement learning, and more particularly to, optimizing reinforcement learning based on the stability of the reinforcement learning state.

Reinforcement Learning (RL) is a subfield of Machine Learning but is also a general-purpose formalism for automated decision-making and AI. It is about taking suitable action to maximize reward in a particular situation. It is employed by various software and machines to find the best possible behavior or path it should take in a specific situation. Reinforcement learning can be viewed as an approach which falls between supervised and unsupervised learning. It is not strictly supervised as it does not rely only on a set of labelled training data but is not unsupervised learning because we have a reward which we want our agent to maximize. The agent needs to find the “right” actions to take in different situations to achieve its overall goal. There are three basic concepts in reinforcement learning: state, action, and reward. The algorithm (agent) evaluates a current situation (state), takes an action, and receives feedback (reward) from the environment after each act. Positive feedback is a reward, and negative feedback is negative for making a mistake. Any reinforcement learning task is defined by three things—states, actions and rewards. States are a representation of the current world or environment of the task. The aim, then, is to learn a “policy”, something which tells you which action to take from each state in order to maximize reward.

Lyapunov stability requires the trajectories of the system to remain arbitrarily close to the equilibrium by appropriate choice of the initial state. Lyapunov stability of equilibrium may be discussed by the Lyapunov theory in which the stability can be proven without defining the initial state of system. Lyapunov stability results typically provide us with sufficient conditions. Failure to meet the conditions of a Lyapunov test leaves us with no conclusion and with the need to repeat the test using a different Lyapunov function or to try a different test. For linear systems, Lyapunov stability can provide us with necessary and sufficient stability conditions. Lyapunov functions have been used in various contexts (stability, convergence analysis, design of model reference adaptive systems, etc.).

### SUMMARY

According to one embodiment of the present invention, a computer-implemented method for optimizing reinforcement learning based on a stability of a reinforcement learning state is disclosed. The computer-implemented method includes determining whether a stability of a next reinforcement learning state of a reinforcement learning problem is above a predetermined threshold. The computer-implemented method further includes responsive to determining that the stability of the next reinforcement state is below the predetermined threshold, determining a stability of an alternate next reinforcement learning state of the reinforcement learning problem. The computer-implemented method further includes responsive to determining that the stability of the next reinforcement state is above the predetermined threshold, transitioning from a current reinforcement learning state to the next reinforcement learning state based, at least in part, on determining that the stability of the next reinforcement learning state is above the predetermined threshold.

According to another embodiment of the present invention, a computer program product for optimizing reinforcement learning based on a stability of a reinforcement learning state is disclosed. The computer program product includes one or more computer readable storage media and program instructions stored on the one or more computer readable storage media. The program instructions include instructions to determine whether a stability of a next reinforcement learning state of a reinforcement learning problem is above a predetermined threshold. The program instructions further include instructions to responsive to determining that the stability of the next reinforcement state is below the predetermined threshold, determine a stability of an alternate next reinforcement learning state of the reinforcement learning problem. The program instructions further include instructions to responsive to determining that the stability of the next reinforcement state is above the predetermined threshold, transition from a current reinforcement learning state to the next reinforcement learning state based, at least in part, on determining that the stability of the next reinforcement learning state is above the predetermined threshold.

According to another embodiment of the present invention, a computer system for optimizing reinforcement learning based on a stability of a reinforcement learning state is disclosed. The computer system includes one or more computer processors, one or more computer readable storage media, and computer program instructions, the computer program instructions being stored on the one or more computer readable storage media for execution by the one or more computer processors. The program instructions include instructions to determine whether a stability of a next reinforcement learning state of a reinforcement learning problem is above a predetermined threshold. The program instructions further include instructions to responsive to determining that the stability of the next reinforcement state is below the predetermined threshold, determine a stability of an alternate next reinforcement learning state of the reinforcement learning problem. The program instructions further include instructions to responsive to determining that the stability of the next reinforcement state is above the predetermined threshold, transition from a current reinforcement learning state to the next reinforcement learning state based, at least in part, on determining that the stability of the next reinforcement learning state is above the predetermined threshold.

### BRIEF DESCRIPTION OF DRAWINGS

The drawings included in the present disclosure are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 is a block diagram of a network computing environment suitable for optimizing stability reinforcement learning program 101, generally designated 100, in accordance with at least one embodiment of the present invention.

FIG. 2 depicts a working example of Q-table construction for interdependent multidimensional goals, generally designated 200, in accordance with at least one embodiment of the present invention.

FIG. 3 is a flow chart diagram depicting operational steps for optimizing stability RL program 101, generally designated 300, in accordance with at least one embodiment of the present invention.

FIG. 4 is a block diagram depicting components of a computer, generally designated 400, suitable for executing an optimizing stability reinforcement learning program 101 in accordance with at least one embodiment of the present invention.

FIG. 5 is a block diagram depicting a cloud computing environment 50 in accordance with at least one embodiment of the present invention.

FIG. 6 is block diagram depicting a set of functional abstraction model layers provided by cloud computing environment 50 depicted in FIG. 5 in accordance with at least one embodiment of the present invention.

While the embodiments described herein are amenable to various modifications and alternative forms, specifics thereof have been shown by way of example in the drawings and will be described in detail. It should be understood, however, that the particular embodiments described are not to be taken in a limiting sense. On the contrary, the intention is to cover all modifications, equivalents, and alternatives falling within the spirit and scope of the disclosure.

### DETAILED DESCRIPTION

The present invention relates generally to the field of reinforcement learning, and more particularly to, optimizing reinforcement learning based on the stability of the reinforcement learning state.

In reinforcement learning (RL), understanding the importance and challenges of learning agents that make decisions is of vital importance today, with more and more interest in interactive agents and intelligent decision-making. The key goal of reinforcement learning today is to define the best sequence of decisions that allow the agent to solve a problem while maximizing a long-term reward. That set of coherent actions is learned through the interaction with an environment and observation of rewards in every state of that environment.

There are numerous challenges involved in implementing reinforcement learning for solving various business problems, including environment unpredictability, learning on real systems from limited samples, and state instability. This stems from the fact that reinforcement learning is exploratory in nature. Currently, reinforcement learning agents pick the actions to reach the next state based on exploration and exploitation. The agent collects data on the go since there is no labelled or unlabeled data to guide it with a task goal. The decisions taken by these agents influence the data received. This is why the agent may need to try out different actions to get new data to reach new states.

That being said, the definition of a state is extremely crucial to the learning of the agent. A state that is poorly defined or represented can cause the agent to fail to learn and thereby progress to the next optimized state. The best way to define a state in an environment is usually to start simple and if that does not work, additional information is added to the state that might help inform the decision of the agent.

Conventional reinforcement learning can only make an RL agent take an action to reach the preferred state based on the policy and the maximum reward that is set. Embodiments of the present invention recognize that state instability problems are currently not addressed in reinforcement learning. Current RL algorithms do not include algorithms or processes where it gives an agent the ability to explore the stability of the state, based on which the agent can progress to the corresponding state. Current reinforcement learning methods focus on single state transition for a specific action taken by an RL agent without considering the stability of the state. Embodiments of the present invention recognize the need to find the stability of the state and making a transition decision to the next state based on the stability. Embodiments of the present invention address the problem of unstable states where the RL agent should consider the stability factor of the state as well. Embodiment of the present invention recognize that RL systems should be trained in such a way to be prepared to decide on the transition to the next state based on the stability of the state so that it optimizes the training process for the agent to reach its final goal easier and faster.

Embodiments of the present invention train an RL agent to optimally traverse towards the end goal by allowing it to find the stability of the next state in its trajectory before moving to the next state so that the agent can decide whether to transition to the respective next state or not based on state stability as one of the influencing factors. Embodiments of the present invention observe and measure the reward for the transition. Embodiments of the present invention apply an additional reward for updating the state based on the stability factor.

Embodiments of the present invention train the RL agent to first figure out the corresponding stability of the next state based on the Lyapunov Stability Principle and the time when the state would become unstable. The Lyapunov principle can be replaced by any stability related technique. This is needed for a dynamically changing state and cases where the agent has to perform some actions in the state. The state can be unstable due to uncertain parameters and external disturbance.

The present invention may be a system, a method, and/or a computer program product at any possible technical detail level of integration. The computer program product may include a computer readable storage medium (or media) having computer readable program instructions thereon for causing a processor to carry out aspects of the present.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suit-able combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

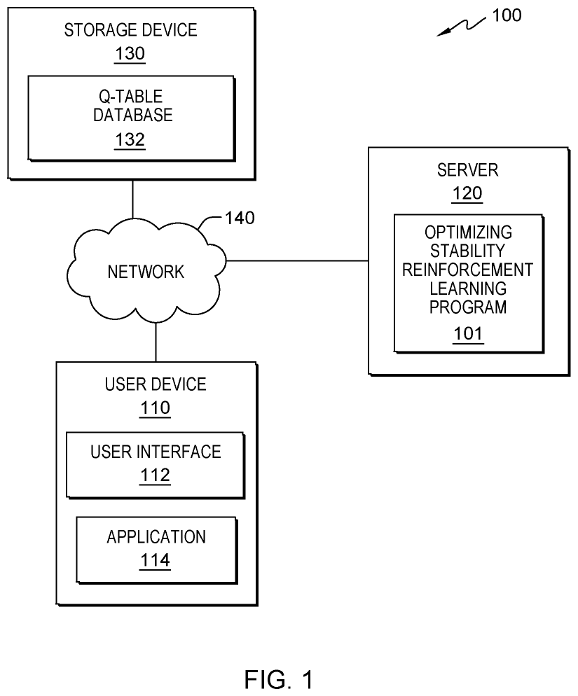

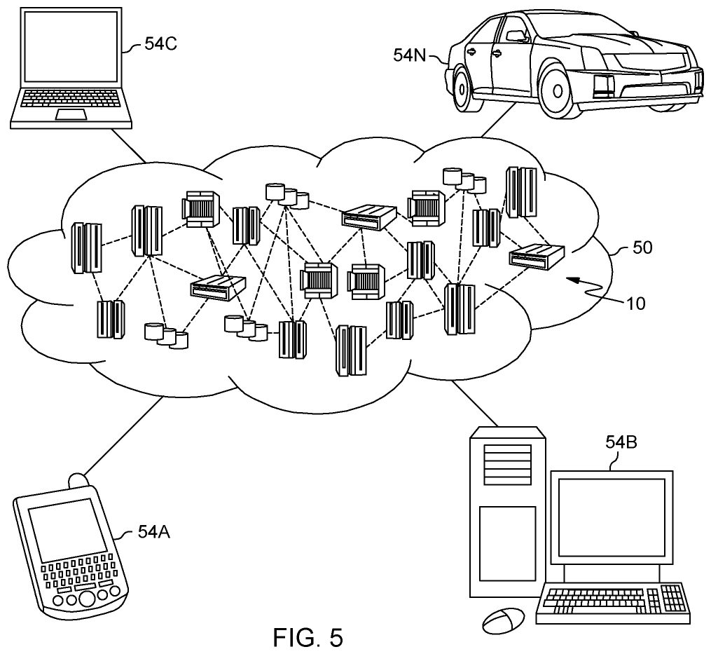

The present invention will now be described in detail with reference to the Figures. FIG. 1 is a block diagram of a network computing environment suitable for optimizing stability reinforcement learning program 101, generally designated 100, in accordance with at least one embodiment of the present invention. In an embodiment, network computing environment 100 may be provided by cloud computing environment 50, as depicted and described with reference to FIG. 5, in accordance with at least one embodiment of the present invention. FIG. 1 provides an illustration of only one implementation and does not imply any limitations with regard to the environments in which different embodiments may be implemented. Many modifications to the depicted environment may be made by those skilled in the art without departing from the scope of the present invention as recited by the claims.

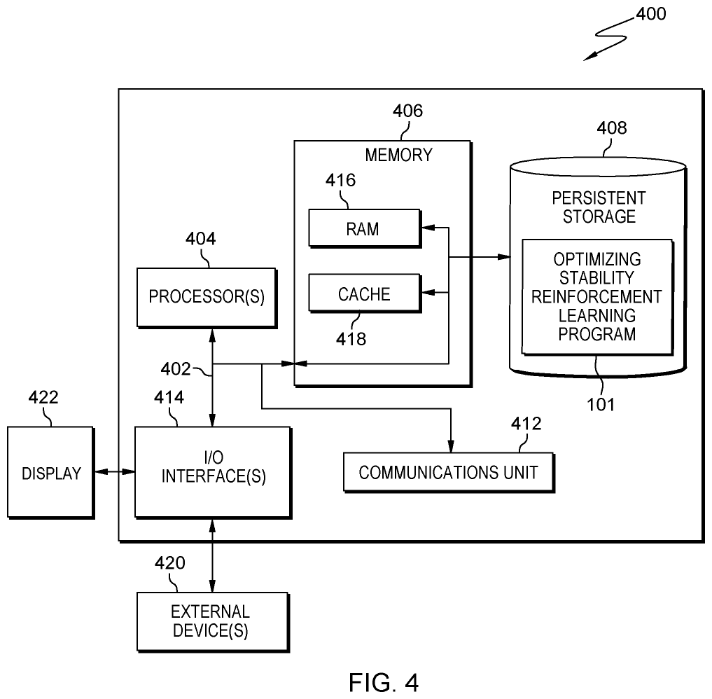

Network computing environment 100 includes user device 110, server 120, and storage device 130 interconnected over network 140. User device 110 may represent a computing device of a user, such as a laptop computer, a tablet computer, a netbook computer, a personal computer, a desktop computer, a personal digital assistant (PDA), a smart phone, a wearable device (e.g., smart glasses, smart watches, e-textiles, AR headsets, etc.), or any programmable computer systems known in the art. In general, user device 110 can represent any programmable electronic device or combination of programmable electronic devices capable of executing machine readable program instructions and communicating with server 120, storage device 130 and other devices (not depicted) via a network, such as network 140. User device 110 can include internal and external hardware components, as depicted and described in further detail with respect to FIG. 4.

User device 110 further includes user interface 112 and application 114. User interface 112 is a program that provides an interface between a user of an end user device, such as user device 110, and a plurality of applications that reside on the device (e.g., application 114). A user interface, such as user interface 112, refers to the information (such as graphic, text, and sound) that a program presents to a user, and the control sequences the user employs to control the program. A variety of types of user interfaces exist. In one embodiment, user interface 112 is a graphical user interface. A graphical user interface (GUI) is a type of user interface that allows users to interact with electronic devices, such as a computer keyboard and mouse, through graphical icons and visual indicators, such as secondary notation, as opposed to text-based interfaces, typed command labels, or text navigation. In computing, GUIs were introduced in reaction to the perceived steep learning curve of command-line interfaces which require commands to be typed on the keyboard. The actions in GUIs are often performed through direct manipulation of the graphical elements. In another embodiment, user interface 112 is a script or application programming interface (API).

Application 114 can be representative of one or more applications (e.g., an application suite) that operate on user device 110. In an embodiment, application 114 is representative of one or more applications (e.g., reinforcement learning applications and machine learning model training applications) located on user device 110. In various example embodiments, application 114 can be an application that a user of user device 110 utilizes to input training data to a reinforcement learning agent and access various Q-tables and their respective Q-values and changes thereto. In an embodiment, application 114 can be a client-side application associated with a server-side application running on server 120 (e.g., a client-side application associated with optimizing stability reinforcement learning program 101). In an embodiment, application 114 can operate to perform processing steps of optimizing stability reinforcement learning program 101 (i.e., application 114 can be representative of optimizing stability reinforcement learning program 101 operating on user device 110).

Server 120 is configured to provide resources to various computing devices, such as user device 110. For example, server 120 may host various resources, such as Q-table database 132, that are accessed and utilized by a plurality of devices. In various embodiments, server 120 is a computing device that can be a standalone device, a management server, a web server, an application server, a mobile device, or any other electronic device or computing system capable of receiving, sending, and processing data. In an embodiment, server 120 represents a server computing system utilizing multiple computers as a server system, such as in a cloud computing environment. In an embodiment, server 120 represents a computing system utilizing clustered computers and components (e.g. database server computer, application server computer, web server computer, webmail server computer, media server computer, etc.) that act as a single pool of seamless resources when accessed within network computing environment 100. In general, server 120 represents any programmable electronic device or combination of programmable electronic devices capable of executing machine readable program instructions and communicating with each other, as well as with user device 110, storage device 130, and other computing devices (not shown) within network computing environment 100 via a network, such as network 140.

In an embodiment, server 120 includes optimizing stability reinforcement learning program 101 (optimizing stability RL program 101). Server 120 may include components as depicted and described in detail with respect to cloud computing node 10, as described in reference to FIG. 5, in accordance with at least one embodiment of the present invention. Server 120 may include components, as depicted and described in detail with respect to computing device 400 of FIG. 4, in accordance with at least one embodiment of the present invention.

In various embodiments, storage device 130 is a secure data repository for persistently storing Q-table database 132 utilized by various applications and devices, such as user device 110 and server 120. Storage device 130 may be implemented using any volatile or non-volatile storage media known in the art for storing data. For example, storage device 130 may be implemented with a tape library, optical library, one or more independent hard disk drives, multiple hard disk drives in a redundant array of independent disks (RAID), solid-state drives (SSD), random-access memory (RAM), and any possible combination thereof. Similarly, storage device 130 may be implemented with any suitable storage architecture known in the art, such as a relational database, an object-oriented database, or one or more tables.

In an embodiment, optimizing stability RL program 101 may be configured to access various data sources, such as Q-table database 132, that may include personal data, content, contextual data, or information that a user does not want to be processed. Personal data includes personally identifying information or sensitive personal information as well as user information, such as location tracking or geolocation information. Processing refers to any operation, automated or unautomated, or set of operations such as collecting, recording, organizing, structuring, storing, adapting, altering, retrieving, consulting, using, disclosing by transmission, dissemination, or otherwise making available, combining, restricting, erasing, or destroying personal data. In an embodiment, optimizing stability RL program 101 enables the authorized and secure processing of personal data. In an embodiment, optimizing stability RL program 101 provides informed consent, with notice of the collection of personal data, allowing the user to opt in or opt out of processing personal data. Consent can take several forms. Opt-in consent can impose on the user to take an affirmative action before personal data is processed. Alternatively, opt-out consent can impose on the user to take an affirmative action to prevent the processing of personal data before personal data is processed. In an embodiment, optimizing stability RL program 101 provides information regarding personal data and the nature (e.g., type, scope, purpose, duration, etc.) of the processing. In an embodiment, optimizing stability RL program 101 provides a user with copies of stored personal data. In an embodiment, optimizing stability RL program 101 allows for the correction or completion of incorrect or incomplete personal data. In an embodiment, optimizing stability RL program 101 allows for the immediate deletion of personal data.

In an embodiment, Q-table database 132 includes various Q-tables used in different reinforcement learning environments for different problems. For each reinforcement learning problem, each Q-table state, its respective Q-values, and changes thereto are updated and recorded in Q-table database 132. In an embodiment, optimizing stability RL program 101 generates a Q-table and stores the generated Q-table in Q-table database 132. In an embodiment, the Q-tables for all the actions of a reinforcement learning problem are Q(s,a). In an embodiment, Q-table database 132 includes information on the maximum expected future rewards for action at each state. In an embodiment, optimizing stability RL program 101 accesses Q-table database 132 to update one or more rewards for actions at one or more states.

In an embodiment, optimizing stability RL program 101 identifies a Q-table for a particular state. In an embodiment, optimizing stability RL program 101 receives a Q-table at an initial state. In an embodiment, optimizing stability RL program 101 generates a Q-table at an initial state. Each Q-table includes “n” columns, where n=number of actions, and “m” rows, where m=number of states. The current state “s” is observed by optimizing stability RL program 101 so that it can select a preferred action for determining a current state of a Q-table.

In an embodiment, optimizing stability RL program 101 determines a current state of a Q-table. In an embodiment, optimizing stability RL program 101 observes the current state ‘s’. In an embodiment, optimizing stability RL program 101 selects a preferred action in a particular step within a current state to reach the desired next step in the current state. In an embodiment, optimizing stability RL program 101 selects a preferred action in a current state to reach the desired next state.

In an embodiment, optimizing stability RL program 101 chooses the action with the highest Q-value by balancing between exploration and exploitation from the current state using epsilon greedy search algorithm. An epsilon greedy algorithm is a method to balance exploration and exploitation by choosing between exploration and exploitation randomly. The epsilon-greedy search algorithm, where epsilon refers to the probability of choosing to explore, exploits most of the time with a small chance of exploring.

In an embodiment, optimizing stability RL program 101 is trained to determine the corresponding stability of the next state based on the Lyapunov Stability Principle. In an embodiment, an additional influencing parameter of Stability of the State is included to determine whether optimizing stability RL program 101 moves to the next state. In an embodiment, the stability of the state is the same as a stability factor. The following is the Lyapunov stability theorem which needs to be satisfied by the next state for optimizing stability RL program 101 to traverse:

x(k+1)=∂f[x(k)]∂x(k)lx(k)=0x(k)+f2[x(k)],k=0,1,2, . . .

where f2[·] is a function including all terms of order higher than one.

The equation can be rewritten in the form:

x(k+1)=Ax(k)+f2[x(k)],k=0,1,2, . . . A=∂f[x(k)]∂x(k)lx(k)=0

In the vicinity of the origin, the behavior is approximately the same as that of the linear system: x(k+1)=Ax(k).

In an embodiment, the equilibrium point of the nonlinear system of with linearized model is asymptotically stable if all the eigenvalues of A are inside the unit circle. Eigenvalues are a special set of scalars associated with a linear system of equations (i.e., a matrix equation) that are sometimes also known as characteristic roots, characteristic values, proper values, or latent roots. In an embodiment, the equilibrium point of the nonlinear system of the linearized model is unstable if one or more of the eigenvalues of A are outside the unit circle. In an embodiment, if one or more eigenvalues of A are on the unit circle, then the stability of the nonlinear system cannot be determined from the linear approximation.

Based on the determined stability of the state, optimizing stability RL program 101 decides on whether to navigate to the corresponding state, or try a different next state. In an embodiment, if the stability of the state is determined to be “Stable”, then optimizing stability RL program 101 moves to the selected next state. In an embodiment, if the stability of the state is determined to be “Unstable”, then optimizing stability RL program 101 does not move to that unstable state and instead picks a different preferred next state, determines the stability of the different preferred next state, and repeats the process.

In an embodiment, optimizing stability RL program 101 selects the best relevant action to traverse from the current state to the next stable state. In an embodiment, optimizing stability RL program 101 performs a selected action to transit from the current state ‘s’ to the stable state.

In an embodiment, optimizing stability RL program 101 observes and measures the reward for an action taken in the previous step (i.e. a reward is given to optimizing stability RL program 101 for moving from the current state “s” to the next new state). In an embodiment, optimizing stability RL program 101 is provided with an additional reward when optimizing stability RL program 101 traverses to a stable state. This additional reward is to encourage optimizing stability RL program 101 to explore to find additional stable states.

In an embodiment, the Bellman equation is used to find the value of a state. In an embodiment, the value of a state is decomposed into an immediate reward for moving to another state and value of the next successor state with a discount factor. This is the observed reward, and this is updated as Q value in the Q-table. The immediate reward is the reward for traversing to a next state, regardless of the stability of the next state. In an embodiment, the discount factor is the additional reward given based on the stability of the state. In an embodiment, the maximum possible reward is the immediate reward plus the discount (i.e., additional reward) for the next state being the state with the highest or greatest stability.

This is repeated for all the states that the agent can move from the current state. In an embodiment, the maximum possible reward is identified by moving to a state which has the maximum state value determined by the previous steps. In an embodiment, optimizing stability RL program 101 computes the temporal difference between each traversed state. The traversed state is the state optimizing stability RL program 101 moves to. The temporal difference is the difference between Q values of 2 different states, based on which the agent moves. In an embodiment, the temporal difference is learned from a particular reinforcement learning environment through episodes with no prior knowledge of the environment. If it is positive, the agent moves to a first state and if negative it moves to a second, different state. It is the objective to find a state with the highest Q value.

In an embodiment, optimizing stability RL program 101 updates one or more Q-values of a Q-table for the previous state using the observed reward and the maximum reward possible for the next state. In an embodiment, optimizing stability RL program 101 updates one or more Q-values of a Q-table using the temporal difference learned between two states and Bellman's Equation. In an embodiment, the Bellman Equation is a condition for optimality associated with the mathematical optimization method known as dynamic programming.

In an embodiment, optimizing stability RL program 101 updates one or more Q-values for the current reinforcement learning state based, at least in part, on applying an observed reward for transitioning to the next reinforcement learning state and a maximum possible reward for transitioning to the next reinforcement learning state. In an embodiment, the observed reward for transitioning to the next reinforcement learning state is calculated based, at least in part, on an immediate reward for transitioning to the next reinforcement learning state and a value associated with the next reinforcement learning state.

In an embodiment, optimizing stability RL program 101 traverses or transitions from one state to the next stable state in a given trajectory, thereby reaching the target goal via the best optimal policy and in a stable way. In an embodiment, optimizing stability RL program 101 can be utilized in a deep neural network to estimate the Q-values for each state-action pair in a given environment, and in turn, the network will approximate the optimal Q-function.

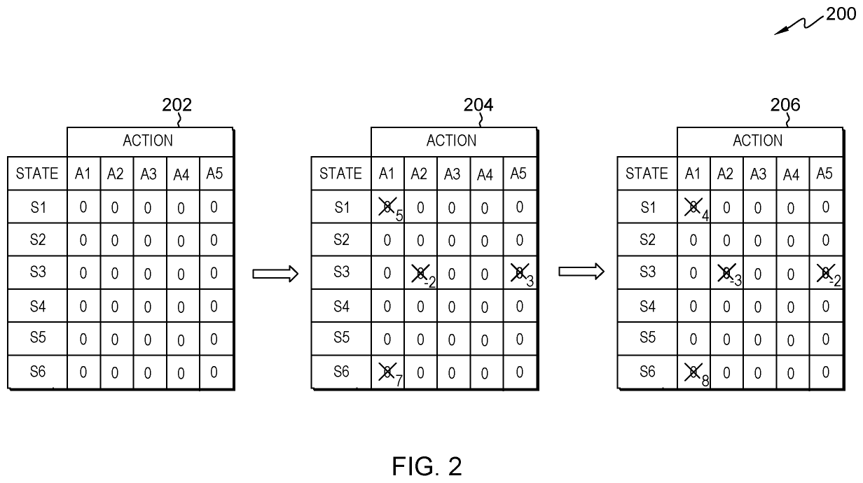

FIG. 2 depicts a working example of Q-table construction for interdependent multidimensional goals, generally designated 200, in accordance with at least one embodiment of the present invention. It should be noted that all values in Q-tables 202, 204, and 206 are in the vector format. FIG. 2 includes initial Q-table 202 with action columns A1-A5 and state rows S1-S6. As depicted, Q-table 202 has been initialized to zero, in which Q(s,a)=0. Based on the following equation: q*(s,a)=E[Rₜ₊₁+γmax_{a(a′)}q*(s′,a′)], where R is a multidimensional reward comprising of a value for each sub-goal, optimizing stability RL program 101 updates respective Q-values for particular actions in a given state. As depicted in FIG. 2, Q-table 204 includes updated Q-values at time t=1 As depicted in Q-table 204, Q-value 0 in state row S1 and action row A1 was updated from 0 to 5. Q-value 0 in state row S3 and action row A2 was updated from 0 to −2. Q-value 0 in state row S3 and action row A5 was updated from 0 to 3. Q-value 0 in state row S6 and action row A1 was updated from 0 to 7.

Based on the following equation: q^{new}(s,a)=(1−α) q(s,a)+α(Rₜ₊₁+γmaxq(s′,a′)), where R is a multidimensional reward comprising of a value for each sub-goal, q(s,a) is an old value and α(Rₜ₊₁+γmaxq(s′,a′)) is the newly computed value, optimizing stability RL program 101 again updates respective Q-values for particular action in a given state. As depicted in FIG. 2, Q-table 206 updated Q values at a future time t=4. As depicted in Q-table 206, Q-value 0 in state row S1 and action row A1 was updated from 0 to 4. Q-value 0 in state row S3 and action row A2 was updated from 0 to −3. Q-value 0 in state row S3 and action row A5 was updated from 0 to −2. Q-value 0 in state row S6 and action row A1 was updated from 0 to 8.

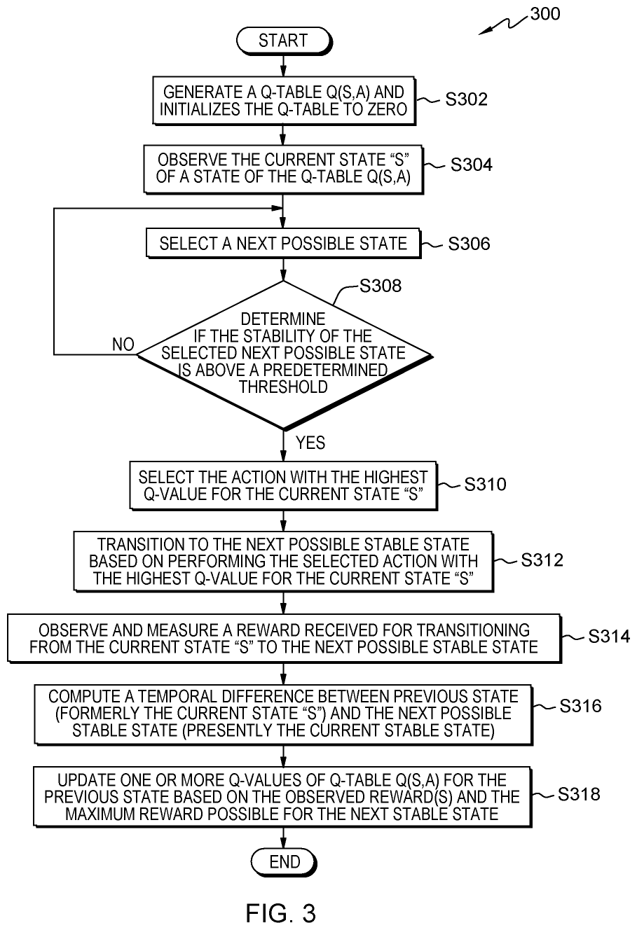

FIG. 3 is a flow chart diagram depicting operational steps for optimizing stability RL program 101, generally designated 300, in accordance with at least one embodiment of the present invention. FIG. 3 provides only an illustration of one implementation and does not imply any limitations with regard to the environments in which different embodiments may be implemented. Many modifications to the depicted environment may be made by those skilled in the art without departing from the scope of the invention as recited by the claims.

At step S302, optimizing stability RL program 101 generates a Q-table Q(s,a) and initializes the Q-table to zero.

At step S304, optimizing stability RL program 101 observes the current state “s” of a state of the Q-table Q(s,a).

At step S306, optimizing stability RL program 101 selects a next possible state.

At decision step S308, optimizing stability RL program 101 determines if the stability of the selected next possible state is above a predetermined threshold. In an embodiment, optimizing stability RL program 101 is trained to determine the corresponding stability of the next state based on the Lyapunov Stability Principle. If optimizing stability RL program 101 determines the stability of the next possible state is not above a predetermined threshold (decision step S308 “NO” branch), optimizing stability RL program 101 returns to step S306 and selects a different next possible state. If optimizing stability RL program 101 determines the stability of the next possible state is above a predetermined threshold (decision step S308 “YES” branch), optimizing stability RL program 101 proceeds to step S310.

At step S310, optimizing stability RL program 101 selects the action with the highest Q-value for the current state “s”. In an embodiment, optimizing stability RL program 101 determines the action with the highest Q-value for the current state “s” by utilizing the greedy search algorithm.

At step S312, optimizing stability RL program 101 transitions to the next possible stable state based on performing the selected action with the highest Q-value for the current state “s”.

At step S314, optimizing stability RL program 101 observes and measures a reward received for transitioning from the current state “s” to the next possible stable state. In an embodiment, an additional reward is given whenever optimizing stability RL program 101 transitions to a state. Here, the additional reward is considered by optimizing stability RL program 101 when observing and measuring the reward(s) received.

At step S316, optimizing stability RL program 101 computes a temporal difference between previous state (formerly the current state “s”) and the next possible stable state (presently the current stable state).

At step S318, optimizing stability RL program 101 updates one or more Q-values of Q-table Q(s,a) for the previous state based on the observed reward(s) and the maximum reward possible for the next stable state.

FIG. 4 is a block diagram depicting components of a computing device, generally designated 400, suitable for optimizing stability RL program 101 in accordance with at least one embodiment of the invention. Computing device 400 includes one or more processor(s) 404 (including one or more computer processors), communications fabric 402, memory 406 including, RAM 416 and cache 418, persistent storage 408, which further includes optimizing stability RL program 101, communications unit 412, I/O interface(s) 414, display 422, and external device(s) 420. It should be appreciated that FIG. 4 provides only an illustration of one embodiment and does not imply any limitations with regard to the environments in which different embodiments may be implemented. Many modifications to the depicted environment may be made.

As depicted, computing device 400 operates over communications fabric 402, which provides communications between computer processor(s) 404, memory 406, persistent storage 408, communications unit 412, and input/output (I/O) interface(s) 414. Communications fabric 402 can be implemented with any architecture suitable for passing data or control information between processor(s) 404 (e.g., microprocessors, communications processors, and network processors), memory 406, external device(s) 420, and any other hardware components within a system. For example, communications fabric 402 can be implemented with one or more buses.

Memory 406 and persistent storage 408 are computer readable storage media. In the depicted embodiment, memory 406 includes random-access memory (RAM) 416 and cache 418. In general, memory 406 can include any suitable volatile or non-volatile computer readable storage media.

Program instructions for optimizing stability RL program 101 can be stored in persistent storage 408, or more generally, any computer readable storage media, for execution by one or more of the respective computer processor(s) 404 via one or more memories of memory 406. Persistent storage 408 can be a magnetic hard disk drive, a solid-state disk drive, a semiconductor storage device, read-only memory (ROM), electronically erasable programmable read-only memory (EEPROM), flash memory, or any other computer readable storage media that is capable of storing program instructions or digital information.

Media used by persistent storage 408 may also be removable. For example, a removable hard drive may be used for persistent storage 408. Other examples include optical and magnetic disks, thumb drives, and smart cards that are inserted into a drive for transfer onto another computer readable storage medium that is also part of persistent storage 408.

Communications unit 412, in these examples, provides for communications with other data processing systems or devices. In these examples, communications unit 412 can include one or more network interface cards. Communications unit 412 may provide communications through the use of either or both physical and wireless communications links. In the context of some embodiments of the present invention, the source of the various input data may be physically remote to computing device 400 such that the input data may be received, and the output similarly transmitted via communications unit 412.

I/O interface(s) 414 allows for input and output of data with other devices that may operate in conjunction with computing device 400. For example, I/O interface(s) 414 may provide a connection to external device(s) 420, which may be as a keyboard, keypad, a touch screen, or other suitable input devices. External device(s) 420 can also include portable computer readable storage media, for example thumb drives, portable optical or magnetic disks, and memory cards. Software and data used to practice embodiments of the present invention can be stored on such portable computer readable storage media and may be loaded onto persistent storage 408 via I/O interface(s) 414. I/O interface(s) 414 also can similarly connect to display 422. Display 422 provides a mechanism to display data to a user and may be, for example, a computer monitor.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

FIG. 5 is a block diagram depicting a cloud computing environment 50 in accordance with at least one embodiment of the present invention. Cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 4 are intended to be illustrative only and that computing nodes 10 and cloud computing environment 50 can communicate with any type of computerized device over any type of network and/or network addressable connection (e.g., using a web browser).

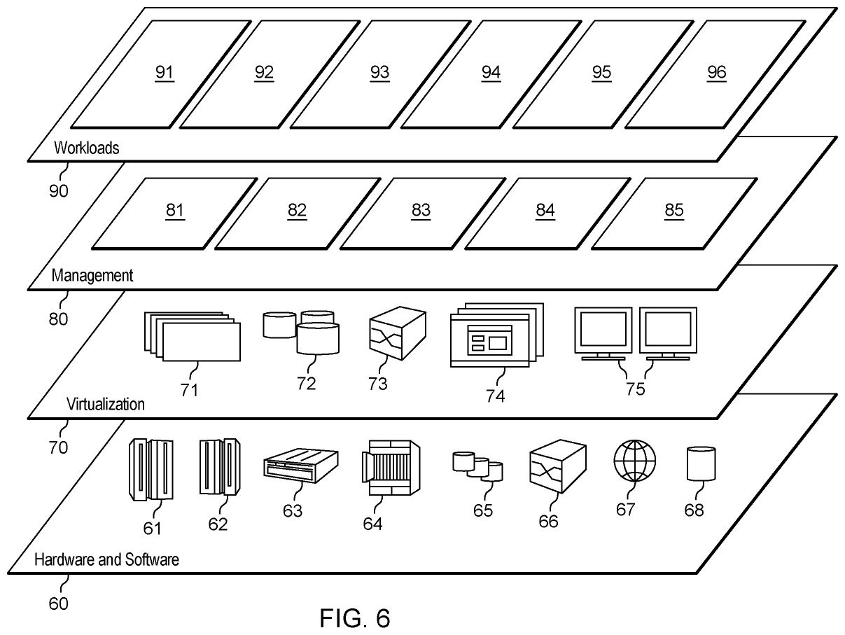

FIG. 6 is block diagram depicting a set of functional abstraction model layers provided by cloud computing environment 50 depicted in FIG. 5 in accordance with at least one embodiment of the present invention. It should be understood in advance that the components, layers, and functions shown in FIG. 6 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and stability reinforcement learning 96.

What is claimed is:

1. A computer-implemented method for optimizing reinforcement learning based on a stability of a reinforcement learning state, the computer-implemented method comprising:
determining whether a stability of a next reinforcement learning state of a reinforcement learning problem is above a predetermined threshold; and
responsive to determining that the stability of the next reinforcement state is below the predetermined threshold:
determining a stability of an alternate next reinforcement learning state of the reinforcement learning problem; and
responsive to determining that the stability of the next reinforcement state is above the predetermined threshold:
transitioning from a current reinforcement learning state to the next reinforcement learning state based, at least in part, on determining that the stability of the next reinforcement learning state is above the predetermined threshold.

2. The computer-implemented method of claim 1, wherein the stability of the next reinforcement learning state of the reinforcement learning problem is determined based on computing a Lyapunov Stability Principle for the next reinforcement learning state.

3. The computer-implemented method of claim 2, wherein the reinforcement learning state is stable if all eigenvalues of A are within a unit circle and the reinforcement learning state is unstable if one or more eigenvalues of A are outside of the unit circle.

4. The computer-implemented method of claim 1, wherein transitioning from the current reinforcement learning state to the next reinforcement learning state is further based on performing an action with a highest Q-value for the current reinforcement learning state.

5. The computer-implemented method of claim 4, wherein a Q-value of the action is computed using a greedy search algorithm.

6. The computer-implemented method of claim 1, further comprising:
updating one or more Q-values for the current reinforcement learning state based, at least in part, on applying an observed reward for transitioning to the next reinforcement learning state and a maximum possible reward for transitioning to the next reinforcement learning state.

7. The computer-implemented method of claim 6, wherein the observed reward for transitioning to the next reinforcement learning state is calculated based, at least in part, on an immediate reward for transitioning to the next reinforcement learning state and a value associated with the next reinforcement learning state.

8. A computer program product for optimizing reinforcement learning based on a stability of a reinforcement learning state, the computer program product comprising one or more computer readable storage media and program instructions stored on the one or more computer readable storage media, the program instructions including instructions to:
determine whether a stability of a next reinforcement learning state of a reinforcement learning problem is above a predetermined threshold; and
responsive to determining that the stability of the next reinforcement state is below the predetermined threshold:
determine a stability of an alternate next reinforcement learning state of the reinforcement learning problem; and
responsive to determining that the stability of the next reinforcement state is above the predetermined threshold:
transition from a current reinforcement learning state to the next reinforcement learning state based, at least in part, on determining that the stability of the next reinforcement learning state is above the predetermined threshold.

9. The computer program product of claim 8, wherein the stability of the next reinforcement learning state of the reinforcement learning problem is determined based on computing a Lyapunov Stability Principle for the next reinforcement learning state.

10. The computer program product of claim 9, wherein the reinforcement learning state is stable if all eigenvalues of A are within a unit circle and the reinforcement learning state is unstable if one or more eigenvalues of A are outside of the unit circle.

11. The computer program product of claim 8, wherein the instructions to transition from the current reinforcement learning state to the next reinforcement learning state is further based on instructions to perform an action with a highest Q-value for the current reinforcement learning state.

12. The computer program product of claim 11, wherein a Q-value of the action is computed using a greedy search algorithm.

13. The computer program product of claim 8, further comprising instructions to:
update one or more Q-values for the current reinforcement learning state based, at least in part, on applying an observed reward for transitioning to the next reinforcement learning state and a maximum possible reward for transitioning to the next reinforcement learning state.

14. The computer program product of 13, wherein the observed reward for transitioning to the next reinforcement learning state is calculated based, at least in part, on an immediate reward for transitioning to the next reinforcement learning state and a value associated with the next reinforcement learning state.

15. A computer system for optimizing reinforcement learning based on a stability of a reinforcement learning state, comprising:
one or more computer processors;
one or more computer readable storage media;
computer program instructions;
the computer program instructions being stored on the one or more computer readable storage media for execution by the one or more computer processors; and
the computer program instructions including instructions to:
determine whether a stability of a next reinforcement learning state of a reinforcement learning problem is above a predetermined threshold; and
responsive to determining that the stability of the next reinforcement state is below the predetermined threshold:
determine a stability of an alternate next reinforcement learning state of the reinforcement learning problem; and
responsive to determining that the stability of the next reinforcement state is above the predetermined threshold:
transition from a current reinforcement learning state to the next reinforcement learning state based, at least in part, on determining that the stability of the next reinforcement learning state is above the predetermined threshold.

16. The computer system of claim 15, wherein the stability of the next reinforcement learning state of the reinforcement learning problem is determined based on computing a Lyapunov Stability Principle for the next reinforcement learning state.

17. The computer system of claim 16, wherein the reinforcement learning state is stable if all eigenvalues of A are within a unit circle and the reinforcement learning state is unstable if one or more eigenvalues of A are outside of the unit circle.

18. The computer system of claim 16, wherein the instructions to transition from the current reinforcement learning state to the next reinforcement learning state is further based on instructions to perform an action with a highest Q-value for the current reinforcement learning state.

19. The computer system of claim 18, wherein a Q-value of the action is computed using a greedy search algorithm.

20. The computer system of claim 16, further comprising instructions to:
update one or more Q-values for the current reinforcement learning state based, at least in part, on applying an observed reward for transitioning to the next reinforcement learning state and a maximum possible reward for transitioning to the next reinforcement learning state.
